(19) United States
(12) Patent Application Publication
(10) Pub. No.: US 2008/0251438 A1
(43) Pub. Date: Oct. 16, 2008

(54) Apparatus for fermenting and drying at high speed

(75) Inventors: In-Sang Yu, Daejeon (KR); Jong-Hyu Sin, Cheongwon-gun (KR)

Correspondence Address: HOLLAND & HART, LLP, P.O BOX 8749, DENVER, CO, 80201, US

(73) Assignee: Ohsung E.R.S. Tech Co., Ltd., Gyeonggi-do (KR)

(21) Appl. No.: 12/080,858

(22) Filed: Apr. 7, 2008

(30) Foreign Application Priority Data
Apr. 11, 2007 (KR) 10-2007-0035443
Mar. 5, 2008 (KR) 10-2008-0020402

(51) Int. Cl. C05F 17/00

(52) U.S. Cl. 210/178

(57) ABSTRACT

An apparatus for rapid fermentation and drying is disclosed. The apparatus includes: a body; a dual jacket type treatment vessel formed in the body; a liquid waste retention basin communicated with the outside; an introduction section for introducing liquid waste stored in the liquid waste retention basin into the treatment vessel; an agitator agitating treated material in the treatment vessel; an energy recycling reaction means having a plurality of heat exchangers connected in series, at least one heater, and at least one catalyst reactor therein; a heater and a heat-exchanging section; a blower supplying the overheated steam discharged from the energy recycling reaction means to the heat-exchanging section of the treatment vessel; a steam/water separator having a heat-exchanging coil therein; an air supply duct having an air pre-heater therein; and a pipeline connected to the two heat-exchanging coils and having a circulation pump.

### TECHNICAL FIELD

The present invention relates to an apparatus for treating organic waste, and more particularly to an apparatus for rapid fermentation and drying which produces raw materials of organic compost by rapidly fermenting and drying organic waste such as livestock waste, food leftovers, and sewage sludge.

### BACKGROUND ART

Conventionally, in a general compost treatment facility for treating livestock manure that is organic waste, when livestock night soil is mixed with an excipient such as sawdust and chaff and is stacked for a long period of time, followed by fermentation in a fermentation chamber to produce compost, leachate is produced, contaminating underground water and soil and generating a large amount of foul smells.

Even in a sewage plant such as a wastewater treatment plant, in order to treat livestock manure, a large-scale facility is needed to treat the sewage of high concentration which is separated into solid and liquid to be discharged and the separated sludge is separately treated, making the perfect treatment of livestock waste water a factor for directly determining the productivity of the livestock industry.

Since ocean dumping of approximately 2,500,000 tons per year of livestock waste water has been gradually reduced from January, 2007 and is scheduled to be completely stopped by 2012, supply of facilities for additionally treating waste and excipients such as sawdust is expected to fail and rapid reproduction of the livestock waste into a material for organic compost without using an excipient is spotlighted as a waste treatment plan suitable for a new concept of recycling and an environment management system.

Especially, since it is essential to remove moisture in the course of treating organic waste, in a mechanical treatment method using a rapid drying unit and a rapid fermentation and drying unit, the treatment costs are different according to methods for supplying an enormous amount of thermal energy corresponding to the latent heat of evaporation of moisture, causing them to be an important factor for determining the utility, and since a large amount of foul smells and gases are contained in the vapor generated in the treatment process, if the vapor is discharged into the air as it is, it causes a serious environmental problem. Therefore, since perfect treatment of the vapor is an important key for management of facilities, apparatus and facilities for perfect treatment of foul smells and gases as well as the treatment of waste are being continuously developed.

Furthermore, other conventional organic waste treatment systems employ treatment methods such as a frequently used adsorption method, an ozone oxidation method, a biological method using bio-media, a washing treatment method using a water booth, a water cooling condensation method using a cooling tower, a rapid cooling treatment method using a refrigeration cycle, a catalyst oxidation treatment method, etc., in order to deodorize the generated vapor and treat the exhaust gas.

When organic waste is treated by mechanical equipment such as a fermentation and drying unit, the thermal energy cost for removing moisture and the facility management cost for deodorizing foul smells occupies the greatest portion in the management cost. When the management cost is disregarded, a low temperature combustion treatment method is the most effective among methods for deodorizing the vapor, foul smells, and gases that are discharged from an organic waste treatment facility.

Although foul smells and gases that are generated in a waste treatment facility are completely oxidized (burned) at a temperature of approximately 900 to 1100 degrees Celsius, according to a treatment method by a catalyst reactor, they are oxidized at a relatively low temperature of approximately 300 to 320 degrees Celsius and are almost completely deodorized when they pass through a catalyst including a honeycomb-shaped carrier coated with platinum, etc.

However, in order to heat 1 CCM of air from approximately 65 to 75 degrees Celsius to approximately 300 degrees Celsius, thermal energy of (1 CMM×60 MIN)×1.24 (average specific gravity of air)×(300 degrees Celsius−65 degrees Celsius)=4,196 kcal/HR should be supplied. Furthermore, since approximately 5 kW/HR of electrical energy is needed when an electric heater is used as an energy source, i.e. in order to treat and discharge 1 CMM of exhaust gas, a high maintenance cost is needed in spite of its excellent deodorizing cost, and if the preheating temperature is low due to lack of the capacity of the electric heater, deodorization becomes incomplete or toxic gases are produced due to incomplete oxidation.

Therefore, even if the treatment method of foul smells and gases by using a platinum catalyst reactor is excellent, since the platinum catalyst carrier is very expensive and the maintenance cost is also high, there are many difficulties in applying it to deodorization equipment of an organic waste treatment facility.

### DISCLOSURE

### Technical Problem

Therefore, the present invention has been made in view of the above problems, and it is an object of the present invention to provide an organic waste treatment apparatus with an energy recycling system that can have a high deodorization effect in spite of its high cost and that can utilize an enormous amount of recovered thermal energy of the vapor and gas, the deodorization of which is almost complete, as the preheating energy and that can recycle the recovered heat as the latent energy for removing the moisture contained in the waste of a treatment vessel, in spite of having a catalyst reactor including a platinum catalyst carrier that is very small as compared with its treatment capacity.

### DESCRIPTION OF DRAWINGS

The above and other objects, features and other advantages of the present invention will be more clearly understood from the following detailed description taken in conjunction with the accompanying drawings, in which:

FIG. 1 is a schematic view illustrating basic equipment of an apparatus for treatment of organic waste according to the present invention;

FIG. 2 is a front view illustrating a body of the apparatus for treatment of organic waste according to the present invention;

FIG. 3 is a plan view of the body of FIG. 2;

FIG. 4 is a left side view of the body of FIG. 2;

FIG. 5 is a right side view of the body of FIG. 2;

FIG. 6 is a concept view for an apparatus for rapid fermentation and drying according to the prevent invention;

FIG. 7 is a detailed view illustrating arrangement of heat-transfer fins provided in a jacket of a treatment vessel of FIG. 6; and

FIG. 8 is an enlarged view of a heat exchanger.

### BEST MODE

Hereinafter, an apparatus for rapid fermentation and drying, to which an organic waste treating apparatus is applied, according to a preferred embodiment of the present invention will be described in detail with reference to the accompanying drawings.

As illustrated in FIG. 1, an apparatus for rapid fermentation and drying according to the embodiment of the present invention includes a body 01, a liquid waste introducing pump 03, a sludge waste introducing screw conveyor 02, a screw conveyor 05 for discharging byproducts, an automatic control panel 10, and a liquid waste retention basin 04.

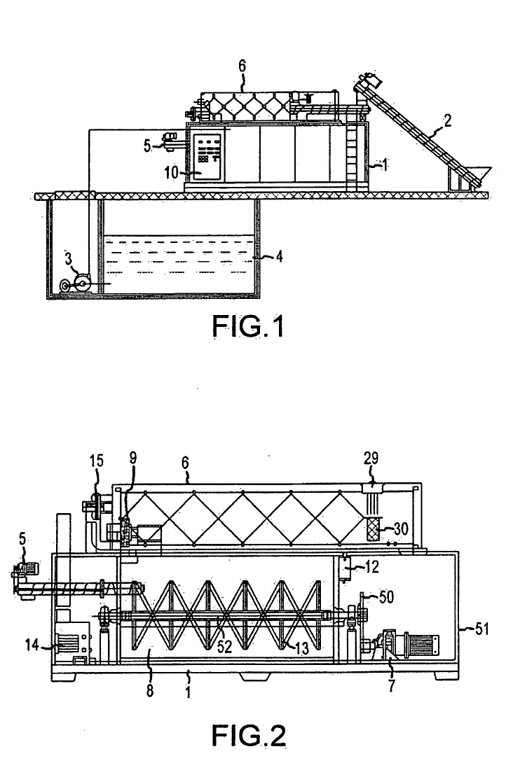

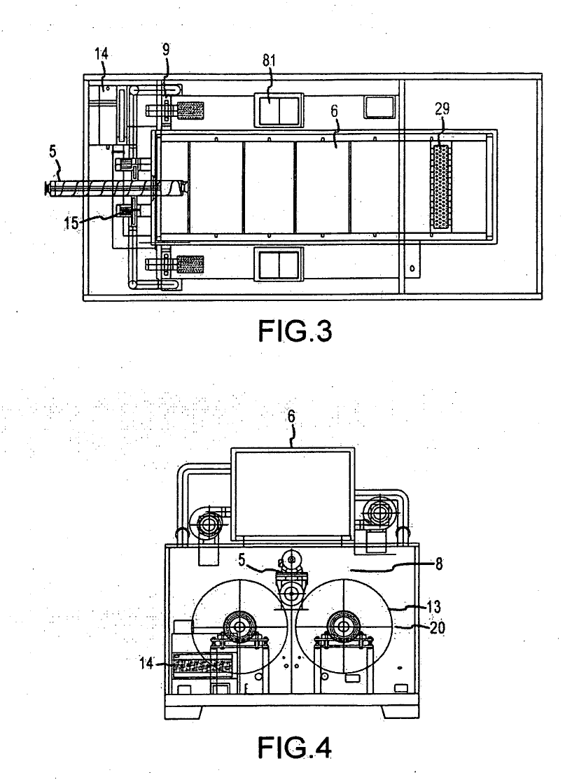

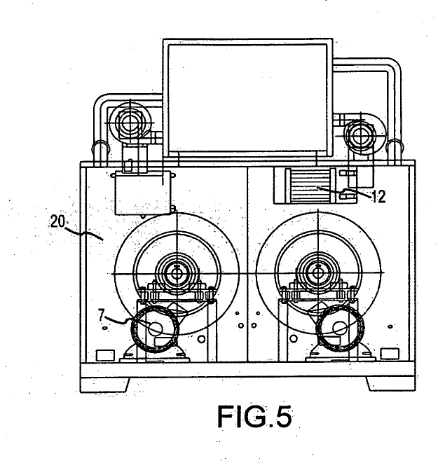

As illustrated in FIGS. 2 to 5, the apparatus for rapid fermentation and drying includes an energy recycling reaction means 06 disposed at an upper portion of the body 01. An outer body is formed in the body by an outer case 51 and a twin type treatment vessel 08 having a dual jacket 20 is formed in the interior of the outer case 51. A ribbon type agitator 13 for agitating treated materials (liquid waste and solid waste) in the treatment vessel 08 is rotatably mounted in the treatment vessel 08.

The agitator 13 is driven by a drive unit including a reduction gear 07, a chain and sprocket mechanism 50, a shaft 52 of the agitator 13, etc. Furthermore, the apparatus for rapid fermentation and drying includes a high pressure blower 09 supplying the vapor including a foul smell generated in the treatment vessel 08 to the energy recycling reaction unit 06, a high pressure blower 15 supplying overheated vapor discharged from the energy recycling reaction means 06 to the jacket 20 of the treatment vessel 08, a steam/water separator 14 and an air pre-heater 12 that are disposed at both ends of the treatment vessel 08, and an inspection opening 81 for checking the interior of the treatment vessel 08.

Moreover, a discharge conveyor OS for discharging byproducts fermented and dried in the interior of the treatment vessel 08 extends from the interior of the treatment vessel 08 outside the body 01.

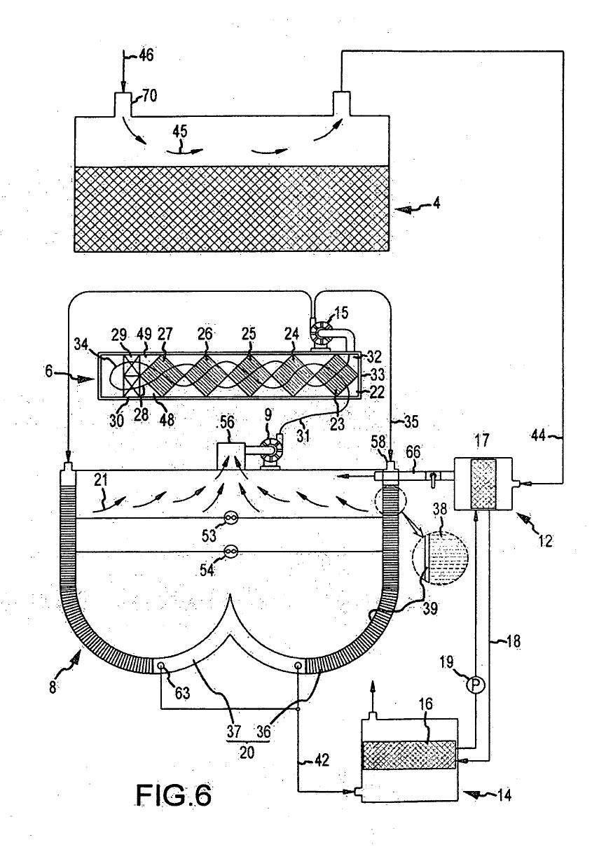

As illustrated in FIG. 6, heat exchangers 23 to 27, a heater 29, and a catalyst reactor 30 are installed in the energy recycling reaction means 06. In the embodiment of the present invention, although one heater and one catalyst reactor are provided in the energy recycling reaction means 06, more than one heater and reactor may be provided according to the specification of the energy recycling reaction means 06.

FIG. 6 is a system diagram illustrating connection among the liquid waste retention basin 04, the treatment vessel 08, the steam/water separator 14, and the air pre-heater 12, a state of processing the vapor containing the foul smell generated in the treatment vessel 08 and the retention basin 04 by stages, and an energy recycling operation.

A heat-exchanging coil 16 is installed in the interior of the steam/water separator 14 so as to circulate a thermal medium obtained by mixing an antifreeze solution and distilled water, and a heat-exchanging coil 17 is installed in the interior of the air pre-heater 12 so as to circulate the thermal medium.

The hot water heating heat-exchanging coil 16 of the steam/water separator 14 and the air preheating heat-exchanging coil 17 of the air pre-heater 12 are connected to each other through a pipeline 18 in which a circulation pump 19 is installed so that the air passing through the air pre-heater 12 can be preheated by using the thermal medium heated in the steam/water separator 14 while the thermal medium is circulating.

In order to maintain the treatment vessel 08 in an optimum treatment environment, the treated material in the treatment vessel 08 is automatically discharged by automatically operating the discharge conveyor 05 through detection of a high level sensor 53 and the discharge conveyor 05 is automatically stopped through detection of a low level sensor 54, by using an electrode type moisture content rate sensor (not shown), so that the treated material or waste in the treatment vessel 08 can maintain a suitable level all the time.

The moisture content rate and environment of the treated material in the treatment vessel 08 can remain almost constant, for example, by automatically introducing one twenty-fourth of an amount of treated material suitable for a day into the treatment vessel 08 every hour.

If the apparatus for rapid fermentation and drying is normally operated for a predetermined period of time, with the treatment vessel 08 being heated by a heater 37 mounted to the bottom surface thereof to a predetermined temperature (for example, 65 to 75 degrees Celsius), the internal temperature of the treatment vessel 08 and the temperature of the treated material become higher.

Then, vapor containing gas 21 is generated in the treatment vessel 08, and the vapor containing gas 21 and the saturated vapor 31 containing the foul smell produced in the treatment vessel 08 are introduced into the heat exchangers 23 to 27 through a suction chamber 22 of the energy recycling reaction means 06 by the high pressure blower 09 via an upper exhaust chamber 56 communicated with the treatment vessel 08.

The saturated vapor 31 passes through the heat exchangers 23 to 27 disposed in series and is heated by stages until its temperature becomes approximately 270 to 280 degrees Celsius at an outlet 49 of the final heat exchanger 27. Then, the overheated vapor 28 discharged from an outlet of the catalyst reactor 30 is responsible for the heating energy, thereby making separate heating energy unnecessary.

The saturated vapor 49 discharged from the outlet 49 of the final heat exchanger 27 is additionally heated by approximately 20 to 40 degrees Celsius, to approximately 300 to 320 degrees Celsius, while passing through an electric heater 29, and then is supplied to the catalyst reactor 30.

The catalyst reactor 30 is composed of a platinum or palladium series honeycomb catalyst, and almost all of the phase changeable materials such as the gases and foul smells that are contained in the gas 34 at an inlet of the catalyst reactor 30 heated to approximately 300 to 320 degrees Celsius are oxidized and converted into carbon gas and vapor, producing oxidation heat, while passing through the catalyst reactor 30.

Consequently, the gas 34 at the inlet is heated to overheated vapor 28 of approximately 320 degrees Celsius after passing through the catalyst reactor 30.

The overheated vapor 28 heated to approximately 320 degrees Celsius by the oxidation heat of the catalyst reactor 30 contains an enormous amount of thermal energy, and flows in a direction opposite to the saturated vapor 31 introduced from the treatment vessel 08, while reversely passing through the heat exchangers 23 to 27 of the energy recycling reaction means 06, so that some of the thermal energy of the overheated vapor 28 heats the saturated vapor 31 of approximately 65 to 75 degrees Celsius to approximately 270 to 280 degrees Celsius. The rest of the thermal energy becomes overheated vapor of approximately 120 to 130 degrees Celsius, and then is introduced into the discharge chamber 32 provided in the energy recycling reaction means 06 and is supplied to the dual jacket 20 of the twin type treatment vessel 08 by the high pressure blower 15 communicated with the discharge chamber 32, so that it can be condensed and discharged to the steam/water separator 14 while functioning as a thermal energy source necessary for the latent heat of evaporation of the moisture in the treatment vessel 08.

The condensate introduced into the steam/water separator 14 is discharged to the outside while functioning as an energy source heating the thermal medium of the heat-exchanging coil 16 provided in the steam/water separator 14, and the thermal medium heated by the condensate flows to the heat-exchanging coil 17 provided in the air pre-heater 12 by the circulation pump 19 to preliminarily heat the air (the air 45 introduced from the liquid waste retention basin 04) introduced into the air pre-heater 12.

The detailed description of the elements of the apparatus for rapid fermentation and drying according to the embodiment of the present invention is as follows:

The energy recycling reaction means 06 is box-shaped and is installed at an upper portion of the body 01, and the outer body is formed by the outer case 33 so as to constitute an energy recycling system. The heat exchangers 23 to 27, the electric heater 29, and the platinum catalyst reactor 30 are disposed in series in the interior of the outer case 33.

As illustrated in FIGS. 6 and 8, each of the heat exchangers 23 to 27 has a hexahedral shape in which a plurality of passages each of which is perpendicular to its adjacent ones are alternately stacked. Two or three of the four transverse corners of each of the hexahedral heat exchangers 23 to 27 are supported by the outer case 33, and one of them makes contact with one corner of the adjacent heat exchanger.

The upper and lower ends of one side of the outer case 33 are divided, by the heat exchanger 23, into the suction chamber 22 and the discharge chamber 32. The heater 29 is disposed on the other side of the outer case 33 at the primary outlet 49 of the heat exchanger 27, and the catalyst reactor 30 is disposed at the secondary inlet 48 of the heat exchanger 27.

The suction chamber 22 has a structure for smoothly introducing the saturated vapor 31 generated in the treatment vessel 08 and supplied by the high pressure blower 09, and the discharge chamber 32 has a structure for smoothly discharging the overheated vapor of approximately 120 to 130 degrees Celsius from the outer case 33.

The electric heater 29 and catalyst reactor 30 consisting of a platinum or palladium series catalyst are provided at the rear end of the outer case 33 that is on the opposite side of the suction and discharge chambers 22 and 32.

The principle of catalyst combustion is that, in order to decompose phase changeable materials, such as a foul smell and gas, that are generated in the process of fermenting and drying wastes, a general direct combustion method needs a high temperature environment of approximately 900 to 1100 degrees Celsius to completely burn and decompose phase changeable materials, but a low temperature combustion method using a catalyst environment almost completely oxidizes phase changeable materials and decomposes the phase changeable materials into carbon dioxide and vapor to enhance the durability of equipment and allows easy recovering and recycling of the combustion reaction heat, thereby remarkably reducing fuels. The catalyst converts the phase changeable materials such as gas and a foul smell into other components that do not generate a foul smell so as to expedite combustion and decomposition at a low temperature.

A platinum or palladium series catalyst is widely used as the catalyst, and a catalyst material such as platinum is coated on a support body having a large surface area, which is molded of a gamma-type aluminum oxide having a large specific surface area into a honeycomb type, a pellet type, a network type, etc. The present invention uses a catalyst reactor in which a porous honeycomb type catalyst treating a large amount of gas and having an excellent efficiency is assembled in several steps or utilizes a pellet type catalyst.

The electric heater 29 for supplying the thermal energy desired for an initial preheating operation and additionally heating the phase changeable gas preheated to approximately 270 to 280 degrees Celsius by approximately 20 to 40 degrees Celsius to increase the combustion efficiency is installed at the rear end of the heat exchanger 27 and the inlet of the catalyst reactor 30, and it is preferable that, since the electric heater 29 has a general structure having a fin coil type electric heater of a predetermined capacity but has a relatively high usage temperature of approximately 300 to 320 degrees Celsius, it is formed of a heat resistant and anticorrosive material.

The embodiment of the present invention is characterized in that, in order to oxidize the phase changeable materials, such as vapor of approximately 65 to 75 degrees Celsius, gas, a foul smell, etc., that are continuously generated in the treatment vessel 08 by using the catalyst reactor to burn the phase changeable materials at a low temperature in a catalyst environment, almost all of the thermal energy for heating the temperature of the gas 34 at the inlet of the catalyst reactor 30 to approximately 300 to 320 degrees Celsius is supplied by recovering an enormous amount of wasted heat contained in the overheated steam 28 at the outlet of the catalyst reactor without supplying external thermal energy.

If the saturated vapor 31, the temperature of which is 65 to 75 degrees Celsius in the chamber 22 at the inlet of the energy recycling reaction means 06, is moved into the chamber 32 at the outlet of the energy recycling reaction means 06 through the heat exchangers 23 to 27, the temperature of the saturated vapor increases to approximately 120 to 130 degrees Celsius due to the oxidation reaction heat generated in the course of burning the phase changeable materials such as gas, a foul smell, etc. at a low temperature in the catalyst reactor 30 and the additional preheating energy of the electric heater 29. The saturated vapor 31 is then discharged from the chamber 32 at the outlet of the energy recycling reaction means 06 and is introduced into the jacket 20 of the treatment vessel 08 to be reutilized as the latent heat for evaporating the moisture contained in the treated material in the treatment vessel 08.

Therefore, the outer wall of the treatment vessel 08 is formed with the dual jacket 20 that is divided into a heat-exchanging section 36, i.e. the heating section using the wasted thermal energy and the heater 37, i.e. the thermal medium heating section for an initial preheating operation and an auxiliary heating operation.

The thermal energy in the overheated vapor 35, the temperature of which is 120 to 130 degrees Celsius and which is supplied through the suction opening 58 of the dual jacket, of the energy recycling reaction means 06 supplies the thermal energy needed for the treated material through the inner tube 39 of the dual jacket 20.

Then, since the treated material in the treatment vessel 08 is in a sludge state in which the moisture content rate is high and the energy source in the dual jacket 20 is in a gaseous state, the heat transfer efficiency of the inner surface of the dual jacket 20, which is on the outer side of the inner tube 39 of the treatment vessel 08, is remarkably low as compared with the temperature of the inner side of the inner tube 39 of the treatment 08, which makes contact with the treated material. Accordingly, it is necessary to enlarge the heat transfer area of the energy recycling heat-exchanging section 36, the heat-exchanging efficiency of which is relatively low, so as to increase the heat-exchanging efficiency.

For this purpose, the treatment vessel 08 according to the embodiment of the present invention has a structure in which heat-transfer fins 38 formed with stainless thin plates are attached to the dual jacket 20 that is the outer surface of the inner tube 39 of the treatment vessel 08 by approximately 3 to 10 mm to maximize the heat-transfer area, and a thermal medium oil is filled in the heater 37, i.e. the thermal medium heating section so as to automatically control the heater 37 to maintain the temperature of 120 to 130 degrees Celsius. The oil, i.e. the thermal medium of a high temperature is naturally circulated by the temperature and the specific gravity thereof to supply the thermal energy into the treatment vessel 08.

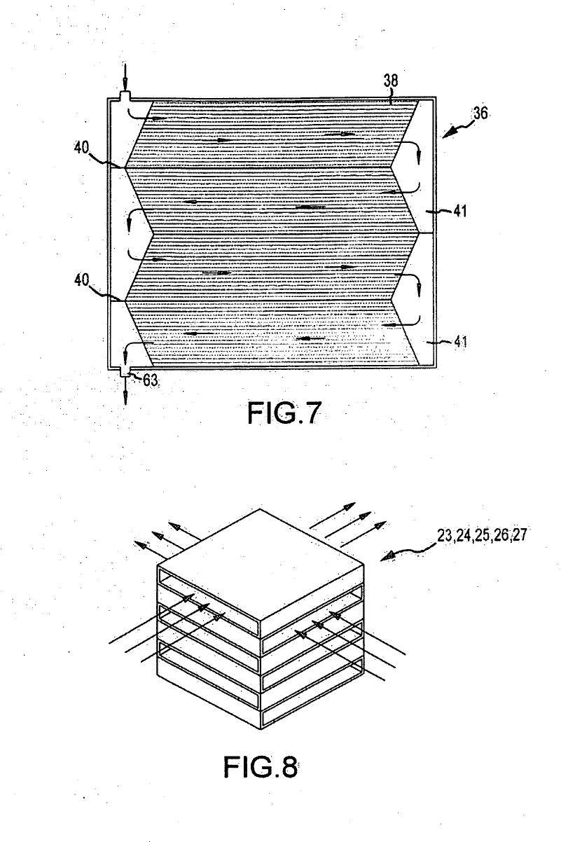

As illustrated in FIG. 7 in detail, since the heat-exchanging section 36 is divided by a plurality of partitions 40 so that the overheated vapor 35 can flow reciprocally and the chamber 41 guiding the gas below the partition 40 is formed as a V-shaped turning chamber by the heat-transfer fins 38 arranged in a stepped manner, the gas circulating the passages divided by the heat-transfer fins 38 can flow smoothly.

When the circulating gas flows reciprocally by stages, the desired thermal energy is supplied into the interior of the treatment vessel 08 and is gradually cooled so that the gas can be discharged through the exhaust opening 63 disposed on the bottom side of the heat-exchanging section 36.

Then, the gas 42 discharged through the exhaust opening 63 of the heat-exchanging section of the treatment vessel 08 is discharged through the steam/water separator 14. The thermal medium heating heat-exchanging coil 16 is installed in the steam/water separator 14 and the air preheating heat-exchanging coil 17 is installed in the air pre-heater 12. The two heat-exchanging coils 16 and 17 are connected to each other by the pipe 18 and the thermal energy of the exhaust gas 42 passing through the steam/water separator 14 is recovered to be supplied to the air pre-heater 12 when the thermal medium obtained by properly mixing an antifreeze solution and distilled water is circulated through the circulation pump 19.

Meanwhile, external air should be supplied into the treatment vessel 18 for the purpose of air supply for aerobic fermentation of the treated material in the treatment vessel 08 and air supply for low temperature combustion of the saturated vapor in the catalyst reactor 30, and for this purpose, the upper end of the retention basin 04 for the liquid waste generating many foul smells is connected to the air supply opening 66 provided in the treatment vessel 08 and is connected to the other end of the air supply duct 44 having the air pre-heater 12 therein.

The liquid waste retention basin 04 includes a vent opening 70 through which external air 46 can be introduced so that the upper air in the liquid waste retention basin 04 can be used as supply air.

The saturated vapor 31 introduced through the suction chamber 22 of the energy recycling reaction means 06 from the treatment vessel 08 is set to be maintained within approximately 65 to 75 degrees Celsius by the treatment vessel 08 of the apparatus for rapid fermentation and drying according to the embodiment of the present invention.

When the temperature of the overheated vapor 28 at the outlet of the catalyst reactor, which is an outlet of a high temperature is 320 degrees Celsius, the saturated vapor 31 introduced into the suction chamber 22 is heated to 110 to 120 degrees Celsius, 150 to 160 degrees Celsius, 190 to 200 degrees Celsius, 230 to 240 degrees Celsius, and 270 to 280 degrees Celsius, whenever the saturated steam 31 of a low temperature passes through the heat exchangers 23, 24, 25, 26, and 27 respectively and is cooled to 280 to 290 degrees Celsius, 240 to 250 degrees Celsius, 200 to 210 degrees Celsius, 160 to 170 degrees Celsius, and 120 to 130 degrees Celsius, whenever the overheated steam of a high temperature passes through the heat exchangers 27, 26, 25, 24, 23 respectively.

### INDUSTRIAL APPLICABILITY

According to the embodiment of the present invention in which, in rapidly fermenting and drying organic waste to convert the organic waste into environment-friendly compost, in order to completely treat the saturated vapor 21 containing phase changeable materials, such as gas, a foul smell, etc., which are generated in the treatment vessel 08 of the apparatus for fermentation and drying, after only preheating energy is initially introduced into the treatment vessel 08, the energy recycling system is basically constituted so as to recycle and reutilize the introduced thermal energy, in order to decompose the phase changeable materials, almost all of the phase changeable materials can be oxidized only with a little energy at a low temperature of approximately 300 to 320 degrees Celsius while a general direct combustion method requires a high temperature environment of approximately 900 to 1100 to completely burn and decompose the phase changeable materials. Furthermore, since carbon dioxide is not generated by burning fossil fuels but is bio-gas produced in the course of fermentation and drying, it is carbon-neutral and can recover and utilize the oxidation reaction heat generated in the catalyst reactor, thereby allowing construction of an organic waste source system of low cost.

Furthermore, according to the present invention, since a branch pipe (not shown) of the air supply duct 44 can make contact with upper portions of the livestock manure storage vessel or the organic waste storage hopper in addition to the liquid waste retention basin 04, the peripheral foul smell can be separately removed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An apparatus for rapid fermentation and drying, comprising:
a body;
a dual jacket type treatment vessel formed in the body so as to be divided;
a liquid waste retention basin communicated with the outside;
an introduction section for introducing liquid waste stored in the liquid waste retention basin into the treatment vessel;
an agitator agitating treated material in the treatment vessel;
an energy recycling reaction means having a plurality of heat exchangers connected in series, at least one heater, and at least one catalyst reactor therein to receive saturated vapor containing a foul smell generated in the treatment vessel and discharge the saturated vapor as overheated steam;
a heater and a heat-exchanging section provided in the dual jacket of the treatment vessel to heat the treatment vessel;
a blower supplying the overheated steam discharged from the energy recycling reaction means to the heat-exchanging section of the treatment vessel;
a steam/water separator having a heat-exchanging coil therein to introduce the overheated steam introduced into the heat-exchanging section and discharge the overheated steam to the outside as condensate;
an air supply duct having an air pre-heater therein, one end of which is connected to an air supply opening of the treatment vessel and the other end of which is connected to the liquid waste retention basin, for the purpose of air supply for aerobic fermentation of the treated material in the treatment vessel and air supply for low temperature combustion of the saturated vapor in the catalyst reactor; and
a pipeline connected to the two heat-exchanging coils and having a circulation pump to circulate the thermal medium between the heat-exchanging coil installed in the steam/water separator and the heat-exchanging coil installed in the air pre-heater.

2. The apparatus as set forth in claim 1, wherein a plurality of heat-transfer fins are attached to the heat-exchanging section of the treatment vessel and are spaced apart from each other.

3. The apparatus as set forth in claim 2, wherein the heat-exchanging section is divided by partitions so that the introduced overheated steam can reciprocally flow, and a chamber guiding the overheated steam below the partitions is formed as a V-shaped turning chamber by a plurality of heat-transfer fins arranged in a stepped manner.

4. The apparatus as set forth in claim 1, wherein the condensate introduced into the steam/water separator is discharged to the outside as an energy source heating the thermal medium of the heat-exchanging coil provided in the steam/water separator and the thermal medium heated by the condensate flows to the heat-exchanging coil provided in the air pre-heater by the circulation pump to preheat the air introduced into the air pre-heater.

5. The apparatus as set forth in claim 1, wherein each of the heat exchangers has a hexahedral shape in which a plurality of passages, each of which is perpendicular to its adjacent ones, are alternately stacked, and two or three of the four transverse corners of each of the hexahedral heat exchangers are supported by the outer case, and one of transverse corners makes contact with one corner of the adjacent heat exchanger, and the upper and lower ends of one side of the outer case are divided, by the heat exchanger, into the suction chamber and the discharge chamber, and the heater is disposed on the other side of the outer case at the primary outlet of the heat exchanger, and the catalyst reactor is disposed at the secondary inlet of the heat exchanger, and the saturated vapor generated in the treatment vessel is introduced into the suction chamber, and the overheated steam is discharged outside the energy recycling reaction means from the discharge chamber.

6. The apparatus as set forth in claim 1, wherein a branch pipe connected to a livestock manure storage vessel and an organic waste storage hopper that generate foul smells is connected to the air supply duct.
